(19) United States
(12) Patent Application Publication
(10) Pub. No.: US 2021/0015021 A1
(43) Pub. Date: Jan. 21, 2021

(54) TILLAGE IMPLEMENT WITH TRAILING COULTER

(71) Applicant: Great Plains Manufacturing, Inc., Salina, KS (US)

(72) Inventors: Rodney D. Hake, Tipton, KS (US); Steve Ahlvers, Glen Elder, KS (US)

(21) Appl. No.: 16/932,253

(22) Filed: Jul. 17, 2020

Related U.S. Application Data
(60) Provisional application No. 62/876,313, filed on Jul. 19, 2019.

(51) Int. Cl. A01B 49/02; A01B 5/04; A01B 35/08; A01B 29/04; A01B 35/06

(52) U.S. Cl. CPC A01B 49/027; A01B 5/04; A01B 35/06; A01B 29/048; A01B 35/08

(57) ABSTRACT

An implement for tilling the soil and methods of using the same. The implement may include cultivator sweeps arranged in staggered rows, trailing coulters positioned behind a rearmost row of the cultivator sweeps, and a finishing attachment positioned proximate the trailing coulters. The trailing coulters are designed to penetrate deeper into the soil than the cultivator sweeps. The method includes passing such an implement through the soil such that the trailing coulters pass through the soil after the sweeps and the finishing attachment passes over and/or through the soil.

### BACKGROUND OF THE INVENTION

Secondary tillage implements such as cultivators, field finishers, and the like generally include a towable frame having a series of transversely extending rows of soil-working implements. For example, some known, horizontal-type cultivators include a row of coulters such as upright discs or other vertically mounted components near the front of the frame, which cut into the soil being cultivated, slicing through plant debris and hardpacked soil crust. Trailing the coulters is a series of sweeps or the like, which lift and turn the soil. Finally, one or more finishing attachments such as a finishing reel is provided on a rearmost portion of the cultivator, which evenly distributes the worked soil and/or prepares the top layer of soil for planting.

These known cultivators are relatively slow because in order to effectively till the soil they cannot be pulled much over 5 mph. Moreover, these implements can leave a horizontal layer of compacted soil beneath the tilled soil, which prevents roots of the crop being planted, water, and other nutrients from effectively penetrating deep into the soil.

Recently, some manufacturers have developed “vertical-type” cultivators—“vertical” in the sense that they eliminate the horizontal cultivator sweeps in an effort to eliminate the residual hardpan—which use a series of tilted discs or the like to work the soil. Some of these vertical-type machines can be pulled at relatively high speeds (e.g., 10-12 mph or even higher). However, these implements require a tremendous amount of horsepower, and thus fuel. There remains a need for an effective, high speed secondary tillage implement with reduced horsepower requirements as compared to known high-speed implements, but which reduces or eliminates the unwanted hardpan produced as a by-product of using a traditional, horizontal-type cultivator.

### BRIEF SUMMARY OF THE INVENTION

The present invention is directed to a secondary tillage implement such as a cultivator or field finisher that includes a plurality of trailing coulters such as a row of upright disc blades. The cultivator is configured to be pulled at relatively high speeds without requiring the tremendous amounts of horsepower necessary to pull known vertical-type, high-speed disc cultivators, while still effectively tilling the soil. Moreover, the trailing coulters penetrate the horizontal layer of compacted soil, or hardpan, traditionally left behind by known horizontal-type cultivators, thus more effectively preparing the soil for seed planting and root penetration.

For example, some embodiments of the invention are directed to an implement for tilling soil that includes a plurality of cultivator sweeps arranged in staggered rows, a plurality of trailing coulters positioned behind a rearmost row of the plurality of cultivator sweeps, and a finishing attachment positioned proximate the plurality of trailing coulters. The plurality of trailing coulters are configured to penetrate deeper into the soil than the plurality of cultivator sweeps.

Other embodiments of the invention are directed to an implement for tilling soil including a plurality of front coulters, a plurality of trailing coulters, a plurality of cultivator sweeps arranged in staggered rows between the plurality of front coulters and the plurality of trailing coulters, and a finishing attachment positioned proximate the plurality of trailing coulters.

Still other embodiments of the invention are directed to a method of tilling soil including passing a plurality of cultivator sweeps through the soil, passing a plurality of trailing coulters through the soil after the plurality of cultivator sweeps, and passing a finishing attachment over and/or through said soil after the plurality of trailing coulters. Each of the plurality of cultivator sweeps is coupled to a vertically extending rear shank, and the plurality of rear shanks and/or the plurality of cultivator sweeps cause lateral movement of the soil. The plurality of trailing coulters, in turn, contact the laterally moving soil to impede further lateral movement of the soil.

These and other features will be discussed in more detail below in connection with the accompanying drawings.

### BRIEF DESCRIPTION OF THE DRAWINGS

The present invention is described in detail below with reference to the attached drawing figures, wherein:

FIG. 1 is a perspective view of a secondary tillage implement according to aspects of the invention;

FIG. 2 is a rear view of the secondary tillage implement shown in FIG. 1;

FIG. 3 is side view of the secondary tillage implement shown in FIGS. 1-2;

FIG. 4 is a top view of the secondary tillage implement shown in FIGS. 1-3;

FIG. 5 is a perspective view of another embodiment of a secondary tillage implement according to aspects of the invention;

FIG. 6 is a side view of the secondary tillage implement shown in FIG. 5;

FIG. 7 is a perspective view of another embodiment of a secondary tillage implement according to aspects of the invention;

FIG. 8 is a side view of the secondary tillage implement shown in FIG. 7;

FIG. 9 is a perspective view of another embodiment of a secondary tillage implement according to aspects of the invention;

FIG. 10 is a side view of the secondary tillage implement shown in FIG. 9;

FIG. 11 is a perspective view of another embodiment of a secondary tillage implement according to aspects of the invention;

FIG. 12 is a side view of the secondary tillage implement shown in FIG. 11;

FIG. 13 is a perspective view of another embodiment of a secondary tillage implement according to aspects of the invention;

FIG. 14 is a side view of the secondary tillage implement shown in FIG. 13;

FIG. 15 is a perspective view of another embodiment of a secondary tillage implement according to aspects of the invention;

FIG. 16 is a side view of the secondary tillage implement shown in FIG. 15;

FIG. 17 is a perspective view of another embodiment of a secondary tillage implement according to aspects of the invention;

FIG. 18 is a side view of the secondary tillage implement shown in FIG. 17;

FIG. 19 is a perspective view of another embodiment of a secondary tillage implement according to aspects of the invention;

FIG. 20 is a side view of the secondary tillage implement shown in FIG. 19;

FIG. 21 is a perspective view of another embodiment of a secondary tillage implement according to aspects of the invention;

FIG. 22 is a side view of the secondary tillage implement shown in FIG. 21;

FIG. 23 is a perspective view of another embodiment of a secondary tillage implement according to aspects of the invention; and

FIG. 24 is a side view of the secondary tillage implement shown in FIG. 23.

### DETAILED DESCRIPTION OF THE INVENTION

Generally, aspects of the present invention include placing a plurality of coulters at the rear of the frame of a horizontal-type secondary tillage implement such as a cultivator, field finisher, or the like. More particularly, the trailing coulters are placed behind the final row of the cultivator sweeps. Traditionally, for horizontal-type cultivators, similar coulters would only be included in front of the sweeps, where they vertically cut into the soil prior to sweeps lifting and turning a top layer of the soil. However, these cultivator sweeps tend to compact the soil just below the top, tilled layer, resulting in horizontal layer of compacted soil several inches below the soil known as hardpan. It has been discovered that by including a plurality of trailing coulters located behind the final row of sweeps and just in front of any finishing attachment, the compacted layer of soil, or hardpan, can be reduced or even eliminated because the trailing coulters slice through the hardpan. Moreover, the trailing coulters serve to level out the soil that has been disrupted by the sweeps, thus enabling the tillage implement to be operated at high speeds without sacrificing tilling performance. Still more, because the secondary tillage implement of the present invention does not include the numerous dirt moving tooling required for known vertical-type, high-speed tillage implements, embodiments of the instant invention have relatively low horsepower (and thus fuel) requirements as compared to other high-speed implements, and thus are more efficient than known tillage implements.

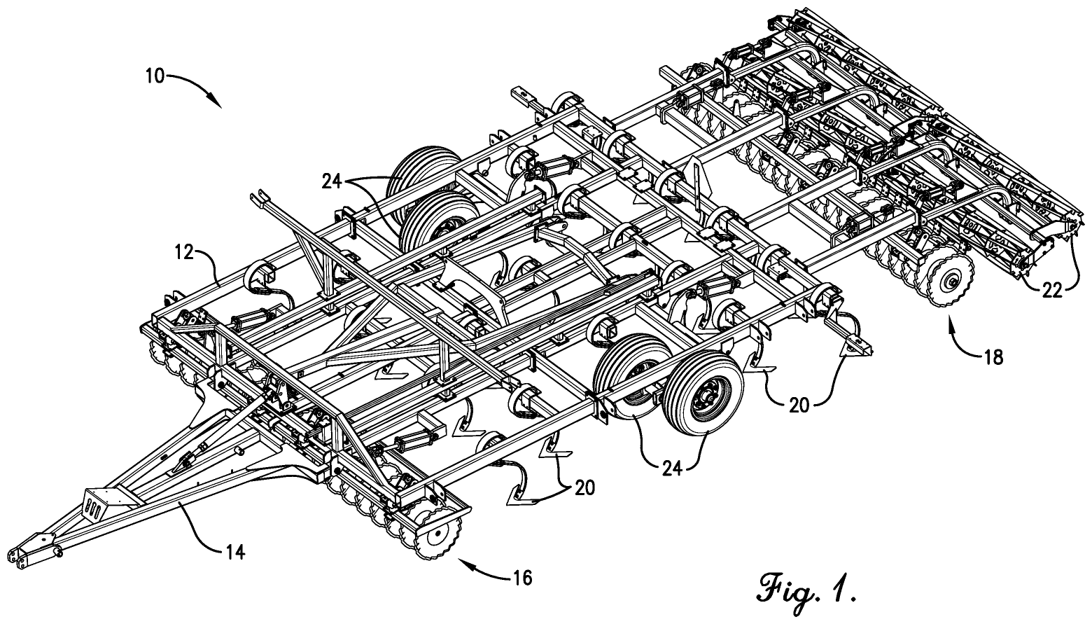

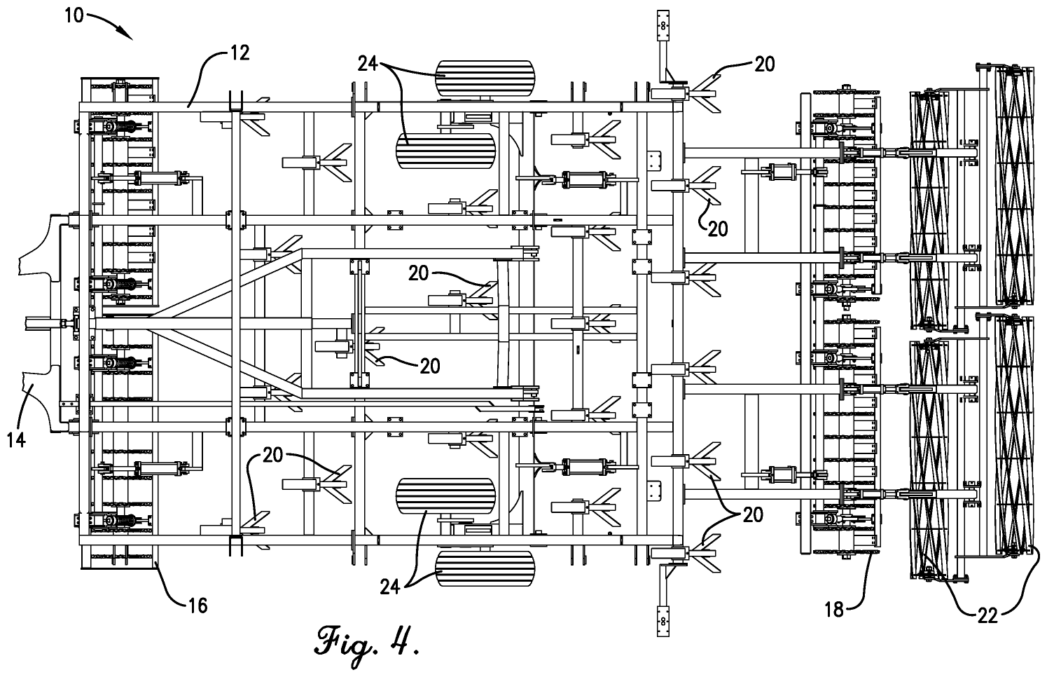

This will be more readily understood first with reference to FIGS. 1-4, which show a first example embodiment of an improved secondary tillage implement 10, such as a cultivator, field finisher, or the like. For convenience, the secondary tillage implement will be referred to simply as a cultivator 10 herein, which should not be interpreted as limiting the types of implements on which aspects of the invention could be employed. The cultivator 10 includes an elongated, rolling frame 12 having a plurality of wheels 24 used to roll across a field, and a pull hitch 14 extending from a front of the frame 12, which removably couples to a tractor or similar vehicle when the cultivator 10 is being pulled across a field. As used herein, “front” refers to an end of the frame 12 nearest a tractor or tow vehicle when the cultivator 10 is being pulled, while “rear” refers to the opposite end of the frame 12; that is, the end of the frame 12 furthest from the tractor or tow vehicle when the cultivator 10 is being pulled.

Near the front of the frame 12 is a first row of coulters 16, which in this embodiment are vertical disc blades but in other embodiments may be any desired type of coulter. For example, in other embodiments the front row of coulters 16 may include other types of generally circular blades, such as, in addition to the flat disc-type blades shown, slightly concave blades or even blades having a substantially conical shape. Moreover, the generally circular blades may include a notched, wavy, or other type of non-smooth outer perimeter without departing from the scope of this invention. The plurality of coulters 16 may be spaced any desired distance from one another and, in some embodiments, are spaced between 5-10 inches apart, and more preferably, are spaced 8 inches from one another. The first row of coulters 16 extend into the soil and cut the ground, resulting in parallel cuts or grooves being formed in the soil.

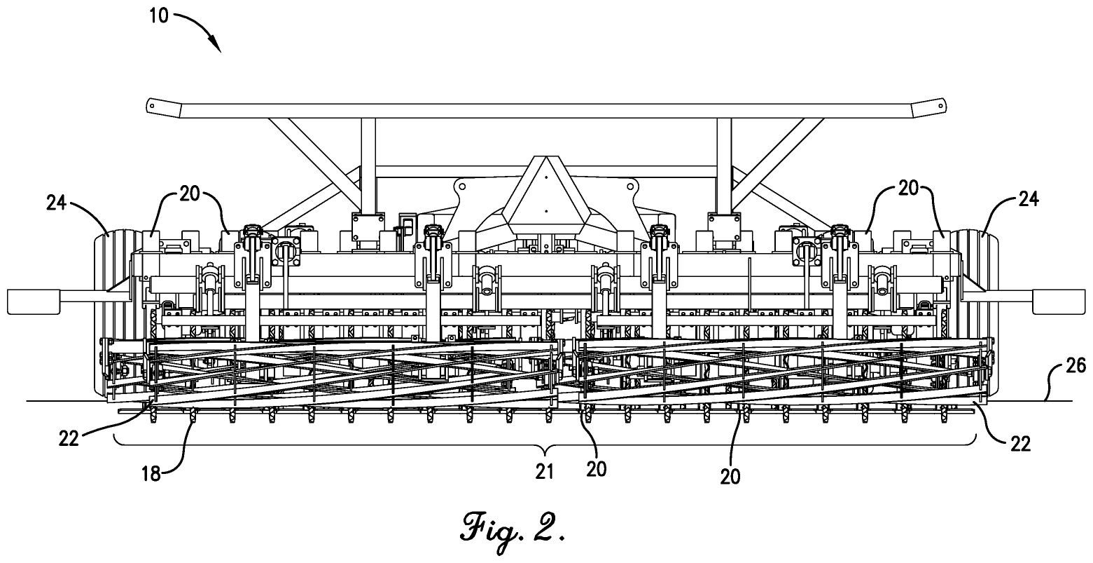

Rearward of the first row of coulters 16 is a plurality of tilling implements 20, which, in the illustrated embodiment, include downward extending shanks with sweeps or shovels attached to the end (referred to herein generally as cultivator sweeps 20, for convenience). The plurality of cultivator sweeps 20 are arranged in staggered rows along the length of the frame 12. For example, the depicted embodiment includes five rows of staggered cultivator sweeps 20, but more or less rows of sweeps 20 can be implemented without departing from the scope of the invention. As best seen in FIG. 2, the plurality of sweeps 20 are arranged such that they are evenly spaced in the lateral direction (that is, a direction extending generally perpendicular to the direction of travel of the cultivator 10). The shanks of the sweeps 20 are spaced any desired distance apart from one another in the lateral direction. For example, in some embodiments the sweeps 20 are connected to the frame 12 is such a way that the shanks of the sweeps are spaced between 5-10 inches apart on center in the lateral direction, and more preferably, such that the shanks of the sweeps 20 are spaced 7 or 8 inches apart on center.

These cultivator sweeps 20 are used to cut the roots of weeds and other plant life below the surface of the soil while also lifting and turning the top surface of the soil thus burying weeds and leftover debris from previous crops, loosening the soil in preparation for the planting of new seeds, among other benefits. The sweeps 20 can be configured to penetrate the soil at any desired depth and, in some embodiments, may penetrate approximately 2-3 inches into the soil.

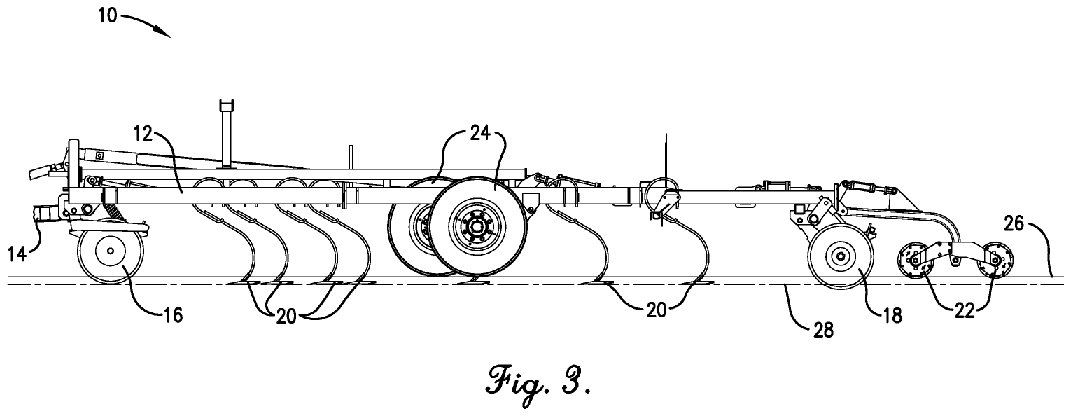

As best seen in FIG. 3, which illustrates the elevation of the top of the soil 26 and the corresponding depth below the soil 26 to which each of the implements extends, the cultivator sweeps 20 extend into the soil to about the same depth as the first row of coulters 16. In this regard, the first row of coulters 16 initially cut and loosen the soil, and then the sweeps 20 flip, turn, or till, the cut soil. For known horizontal-type cultivators, this results in a horizontal layer of compacted soil, also known as hardpan, at about the depth to which the sweeps 20 extend into the soil. This may be best understood with reference to FIG. 2, which shows how, when viewed from the rear, the cultivator sweeps 20 align to form a horizontal shearing plane 21. In this regard, the sweeps 20 shear and compact a horizontal layer a few inches below the surface of the soil 26, thus forming a hardpan through which roots, water, and nutrients have difficulty traversing. This hardpan is schematically illustrated by the broken line 28 in FIG. 3.

Mounted to the rear of the frame 12, behind a final row of sweeps 20, is a second row of coulters 18, again illustrated as vertical disc coulters, although other coulters could be implemented without departing from the scope of this invention. The plurality of coulters 18 may be spaced any desired distance from one another and, in some embodiments, are spaced between 5-10 inches apart, and more preferably, are spaced 7 inches or 8 inches from one another. In some embodiments, the plurality of coulters 18 may be spaced the same distance apart as the shanks of the sweeps 20. Thus, for example, when the shanks of the sweeps 20 are spaced 7 inches apart, the plurality of coulters 18 are also spaced 7 inches apart such that each coulter 18 generally aligns, in the direction of travel of the cultivator 10, with at least one shank of the plurality of sweeps 20 (FIG. 2). In some embodiments, the plurality of coulters 18 are gang mounted on a common shaft or a plurality of shafts, while in other embodiments each of the coulters 18 is independently mounted to the frame 12.

Similar to the first row of coulters 16, the second row of coulters 18 extend into the soil and thus cut the soil through which they are being pulled. In some embodiments, and as best seen in FIG. 3, the second row of coulters 18 extend deeper below the top of the soil 26 than either the first row of coulters 16 or the cultivator sweeps 20. That is, the second row of coulters 18 extend below, and thus cut through, the horizontal layer of compacted soil or hardpan 28 formed by the sweeps 20. The plurality of coulters 18 can be configured to penetrate to any desired depth and, in some embodiments, are configured to penetrate the soil approximately 0.5-6 inches below the horizontal plane created by the sweeps 20, and more preferably approximately 2 inches below the horizontal plane created by the sweeps 20. In this regard, the portion of the frame 12 supporting the second row of coulters 18 is adjustable in the field so that the coulters 18 can be moved to a desired operating depth and/or so the coulters 18 can be moved as the coulters 18 wear and thus the radius of the cutting surface thereof is reduced.

The vertical slices created by the trailing coulters 18 allow for increased openings in the ground for roots, water, nutrients, etc., to pass as compared to the worked soil formed by known horizontal-type cultivators. More particularly, the trailing coulters 18 advantageously reduce or eliminate the hardpan created by known horizontal-type cultivators. The trailing coulters 18 also serve to level the worked soil by moving the soil coming off the sweeps 20 into rows of parallel, shallow mounds that are easily leveled by a finishing attachment, when so equipped. More particularly, and in contrast to known horizontal-type cultivators, providing the plurality of coulters 18 behind the sweeps 20 and aligned with the shanks thereof (again, best seen in FIG. 2) results in a substantially uniform, leveled soil surface, even when the cultivator 10 is being pulled at relatively high speeds (e.g., 8-12 mph).

In some embodiments the second row of coulters 18 are mounted rearward from the final row of sweeps 20 a sufficient distance in order to allow for the back row of sweeps 20 to sufficiently till the soil without interference, yet close enough such that the coulters 18 can contact the laterally moving soil and therefore impede further lateral movement of the soil. That is, by placing the coulters 18 near the final row sweeps 20, the coulters 18 corral soil that may otherwise be displaced too far from the sweeps 20 when the cultivator 10 is operated at high speeds. This corralling effect of the coulters 18 results in a relatively level soil surface leaving the second row of coulters 18. In some embodiments, when measured from a rearward-most portion of the back row of sweeps 20 (i.e., the rearmost portion of the curved shank thereof), a leading edge of the second row of coulters 18 may be mounted about 2-24 inches away and, more preferably, about 10-12 inches away.

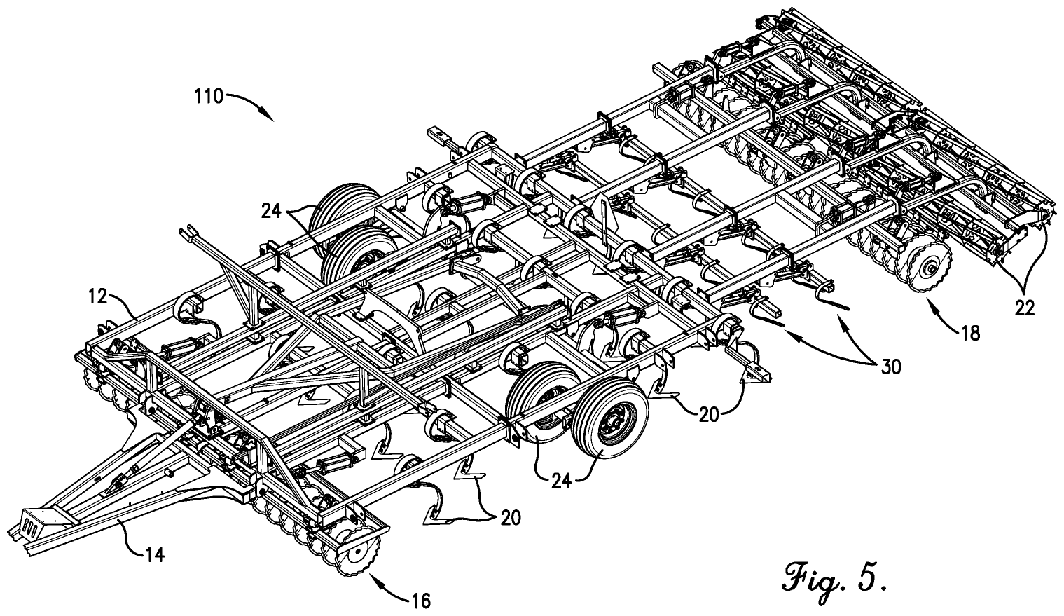

In some embodiments, the cultivator 10 may include one or more finishing attachments such as finishing reels 22 and/or other suitable finishing attachments mounted behind the cultivator sweeps 20 and in front of or behind the second row of coulters 18. For example, in the depicted embodiment the finishing attachments include a pair of finishing reels 22 (also known as rolling harrows, crumble baskets, or similar), but in other embodiments other finishing attachments such as a spring tooth drag, spike tooth drag, cultivator shanks, and others can be implemented in addition to or instead of the finishing reels 22 without departing from the scope of the invention. Moreover, although in the depicted embodiment two finishing reels 22 are utilized, in other embodiments the cultivator 10 may employ more or less finishing reels 22 without departing from the scope of the invention, as will become more apparent below in connection with the discussion of FIGS. 5-24. These finishing reels 22 simultaneously break up large dirt clods and the like left in the soil after the first row of coulters 16, cultivator sweeps 20, and second row of coulters 18 pass over the ground, while additionally knocking down the plurality of shallow mounds left by the second row of coulters 18 and thus leaving an even more level, tilled surface. The finishing reels 22 thus additionally level the soil, preparing it for seeding.

By including the second row of coulters 18 at a rear of the cultivator 10, behind the final row of sweeps 20, the cultivator 10 can be pulled at a faster speed than known horizontal-type cultivators, while requiring only comparable amounts of horsepower per foot. That is, the staggered row of cultivator sweeps 20 lift, flip, and throw the soil laterally; i.e., in a direction perpendicular to the direction of travel of the cultivator 10 as well as perpendicular to the direction in which the coulters 16,18 penetrate into the soil. When traditional, horizontal cultivators are operated at high speed, this soil is tossed farther laterally than is desired, resulting in an uneven result and thus poor tilling performance. However, by including the second row of coulters 18 on the cultivator 10, the soil being laterally thrown by the sweeps 20 collides with the coulters 18, thus preventing further lateral movement, and thus correct placement, of the soil. This allows the cultivator 10 to be pulled at relatively high speeds—i.e., 8-12 mph, or even faster—while achieving similar tillage performance as is achieved by operating traditional, horizontal cultivators at relatively slow speeds—i.e., 4-5 mph.

Moreover, the second row of coulters 18 reduce or even eliminate the horizontal layer of compacted dirt or hardpan 28 formed by the operation of a known cultivator as they penetrate deeper into the soil that the sweeps 20 and thus slicing through the compacted soil.

Additionally, because the cultivator 10 does not include the numerous rows of tilted discs required by most high-speed, disc-type cultivators, which throw large amounts of soil and thus require lots of fuel and horsepower to pull through the soil, the cultivator 10 requires much less horsepower-per-foot than is needed to pull high-speed, disc-type cultivators, resulting in a more efficient tilling operation as much wider cultivators 10 can be pulled as compared to high-speed, disc-type cultivators, given a certain horsepower tractor. For example, although FIGS. 1-4 show only a relatively narrow cultivator 10, it should be appreciated that other sections, sometimes referred to as batwings, may be added to achieve wider tilling paths—sometimes up to 50 feet wide or more. Because of the horsepower-intensive nature of high-speed, vertical-type cultivators, the same tractor that would be used to pull a 50+ foot cultivator of the type described herein could only pull a 25 foot or so high-speed, vertical-type cultivator.

Again, although the embodiment shown in FIGS. 1-4 utilizes two finishing reels 22 as finishing attachments, in other embodiments more or less finishing reels 22 and/or other types of finishing attachments can be implemented such as, e.g., a spring tooth drag, a spike tooth drag, spike harrows, rolling harrows, cultivator shanks, and others without departing from the scope of the invention. This will become more apparent with reference to FIGS. 5-24, which depict other embodiments of the secondary tillage implements including different finishing attachments than those shown in FIGS. 1-4.

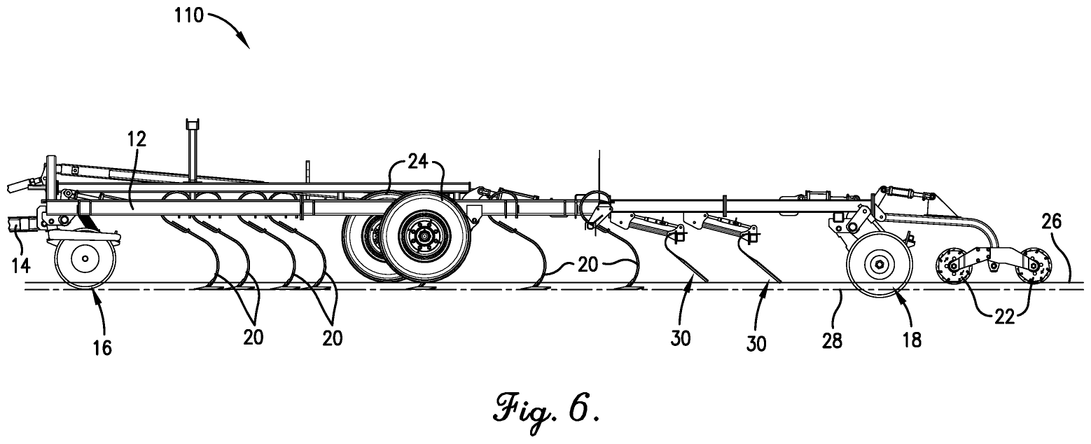

First, FIGS. 5 and 6 show a second tillage implement or cultivator 110 according to a second embodiment of the invention. In FIGS. 5 and 6 and those that follow, like numerals represent like parts as discussed in connection with FIGS. 1-4, and thus will not be discussed again in detail. In this embodiment, the cultivator 110 additionally includes one or more rows of flex tines 30. More particularly, the cultivator 110 includes two rows of flex tines 30, but in other embodiments the cultivator 110 could include more or less flex tines 30 without departing from the scope of the invention. The flex tines 30 serve to further level the soil leaving the cultivator sweeps 20 thus providing a level field suitable for planting.

In this embodiment, the flex tines 30 are disposed behind the final row of cultivator sweeps 20 but in front of the trailing coulters 18. In other embodiments, the flex tines 30 may be provided elsewhere (e.g., behind the trailing coulters 18) without departing from the scope of the invention. Finally, this embodiment includes two finishing reels 22 behind the trailing coulters 18, similar to the embodiment shown and described in connection with FIGS. 1-4, but in other embodiments more or less finishing reels 22 could be implemented or the finishing reels 22 could be eliminated altogether without departing from the scope of the invention.

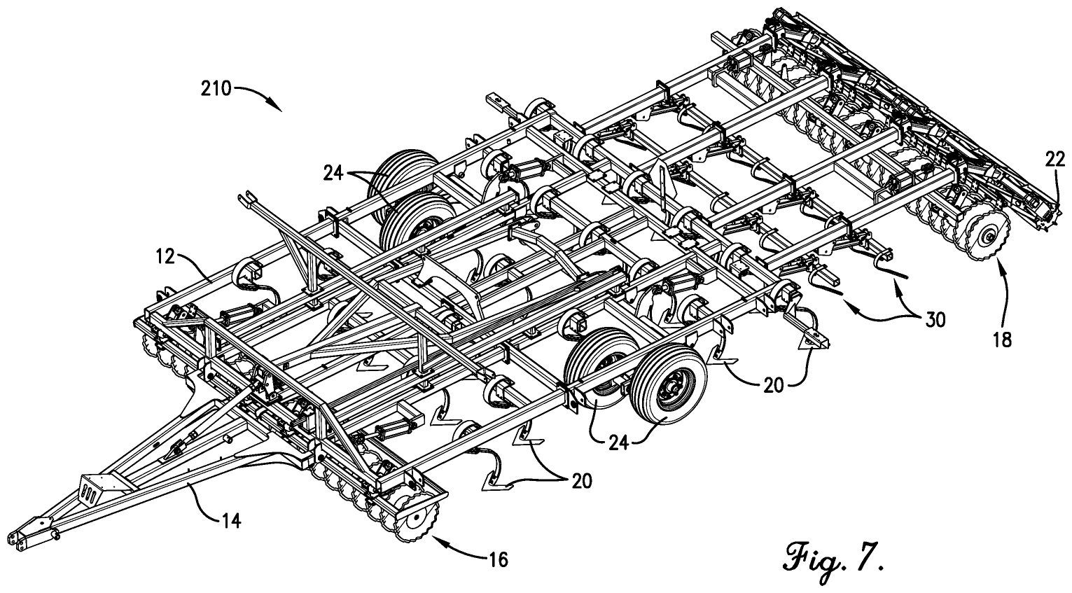

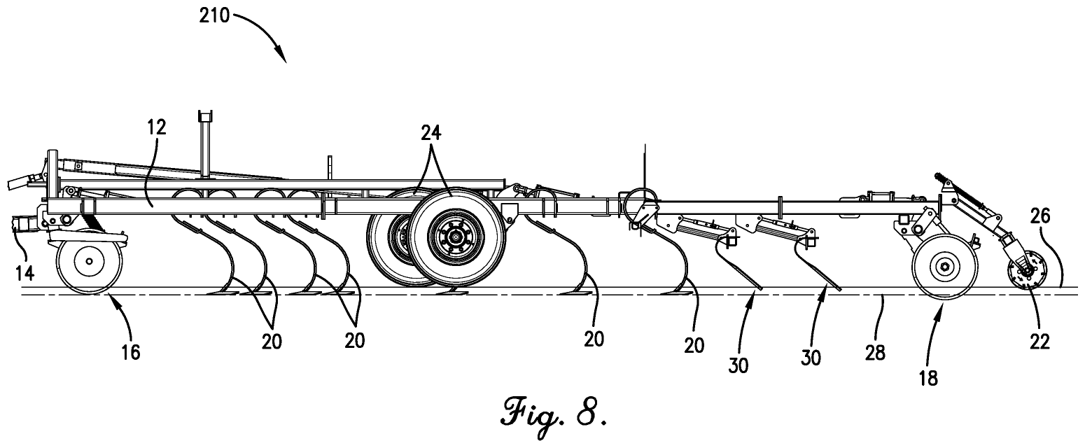

For example, FIGS. 7 and 8 show a third embodiment of a secondary tillage implement or cultivator 210 that includes the flex tines 30 discussed above in connection with FIGS. 5 and 6, but which includes only a single finishing reel 22. In other embodiments the finishing reel(s) 22 may be completely eliminated, moved (such that, e.g., they are provided before the flex tines 30 or otherwise), or even additional finishing reels 22 may be added without departing from the scope of the invention.

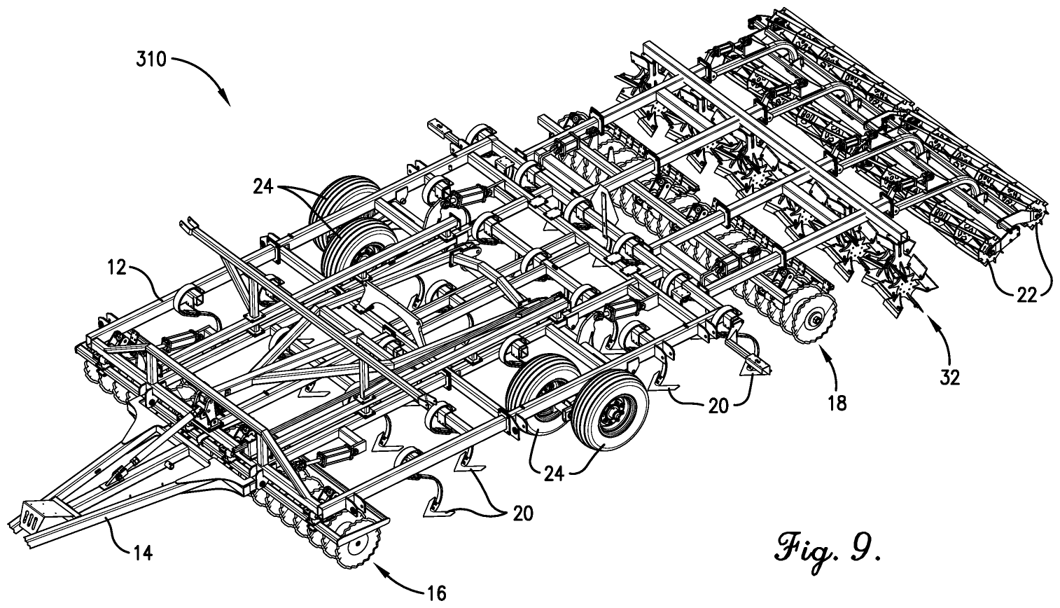

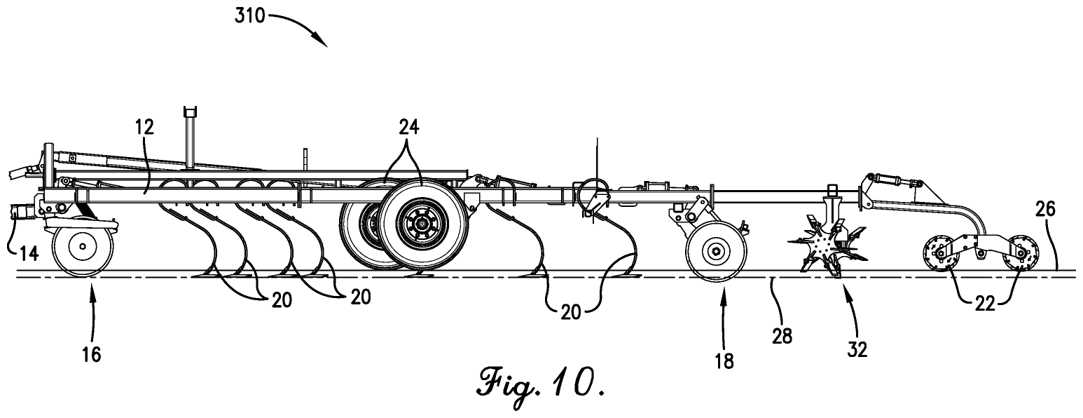

FIGS. 9 and 10 show a secondary tillage implement or cultivator 310 according to a fourth embodiment of the invention. In this embodiment, the cultivator 310 additionally includes an angled chopper wheel 32, such as the chopper wheel described in detail in U.S. Pat. No. 8,714,276, incorporated herein by reference. In other embodiments, the cultivator 310 could include more angled chopper wheels 32 (i.e., two or more) without departing from the scope of the invention. The angled chopper wheel 32 serves to further level the soil leaving the cultivator sweeps 20 and trailing coulters 18 by chopping up clods of soil and crop remnants in mounds leaving the sweeps 20 and coulter 18 and by pushing the mounds into trenches formed by the various implements, thus providing a level field suitable for planting.

In this embodiment, the angled chopper wheel 32 is disposed behind the trailing coulters 18. In other embodiments, the angled chopper wheel 32 may be provided elsewhere (e.g., in front of the trailing coulters 18) without departing from the scope of the invention. Finally, this embodiment includes two finishing reels 22 behind the angled chopper wheel 32, similar to the embodiment shown and described in connection with FIGS. 1-4, but in other embodiments more or less finishing reels 22 could be implemented or the finishing reels 22 could be eliminated altogether without departing from the scope of the invention.

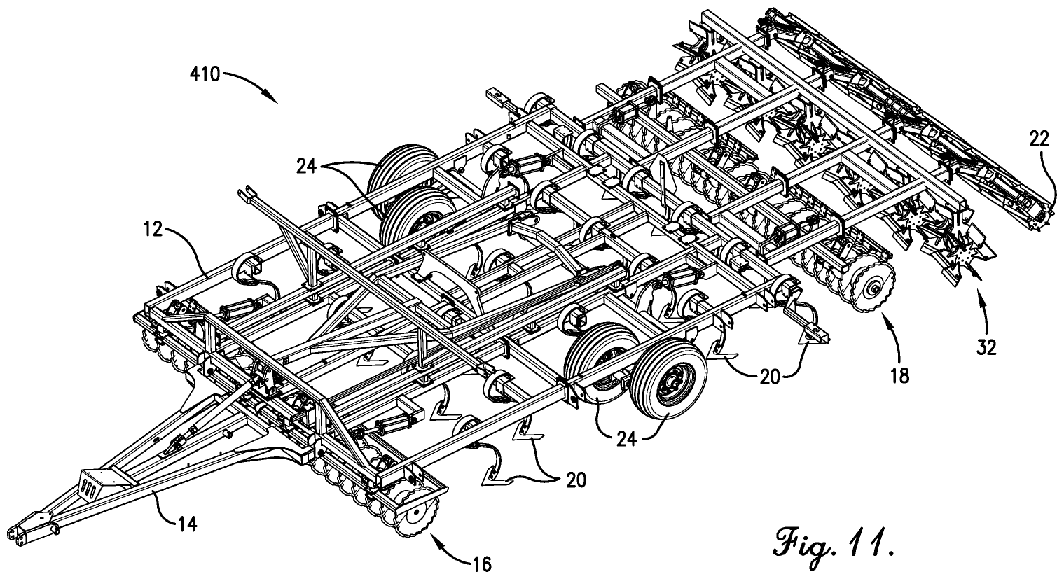

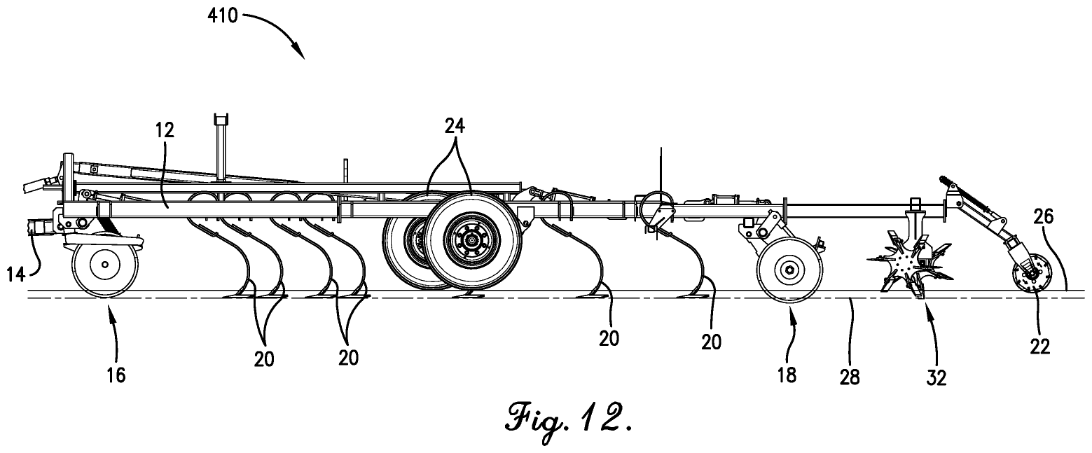

For example, FIGS. 11 and 12 show a fifth embodiment of a secondary tillage implement or cultivator 410 that includes the angled chopper wheel 32 discussed above in connection with FIGS. 9 and 10, but which includes only a single finishing reel 22. In other embodiments the finishing reel(s) 22 may be completely eliminated, moved (such that, e.g., they are provided before the angled chopper wheel 32 or otherwise), or even additional finishing reels 22 may be added without departing from the scope of the invention.

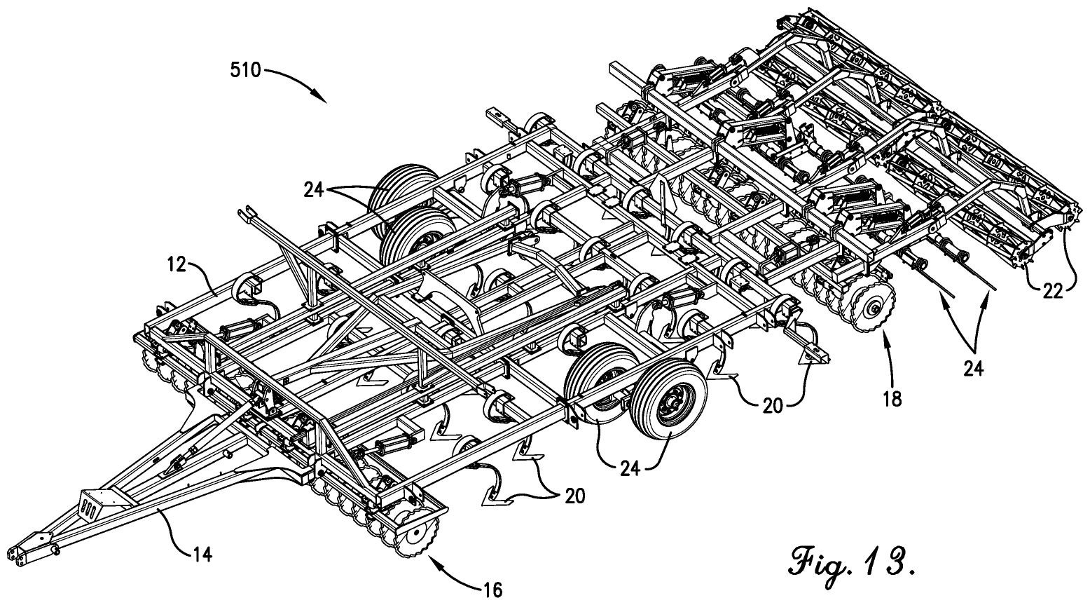

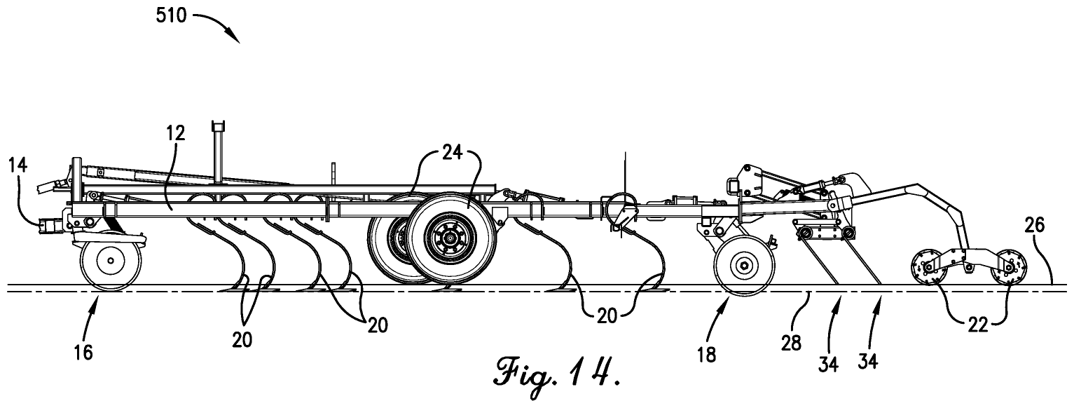

FIGS. 13 and 14 show a secondary tillage implement or cultivator 510 according to a sixth embodiment of the invention. In this embodiment, the cultivator 510 additionally includes a plurality of spring tines 34, generally arranged in two rows. In other embodiments, the cultivator 310 could include more or less spring tines 34 without departing from the scope of the invention. The spring tines 34 serve to further level the soil leaving the cultivator sweeps 20 and trailing coulters 18 by chopping up clods of soil and crop remnants in mounds leaving the sweeps 20 and coulter 18 thus providing a level field suitable for planting.

In this embodiment, the spring tines 34 are disposed behind the trailing coulters 18. In other embodiments, the spring tines 34 may be provided elsewhere (e.g., in front of the trailing coulters 18) without departing from the scope of the invention. Finally, this embodiment includes two finishing reels 22 behind the spring tines 34, similar to the embodiment shown and described in connection with FIGS. 1-4, but in other embodiments more or less finishing reels 22 could be implemented or the finishing reels 22 could be eliminated altogether without departing from the scope of the invention.

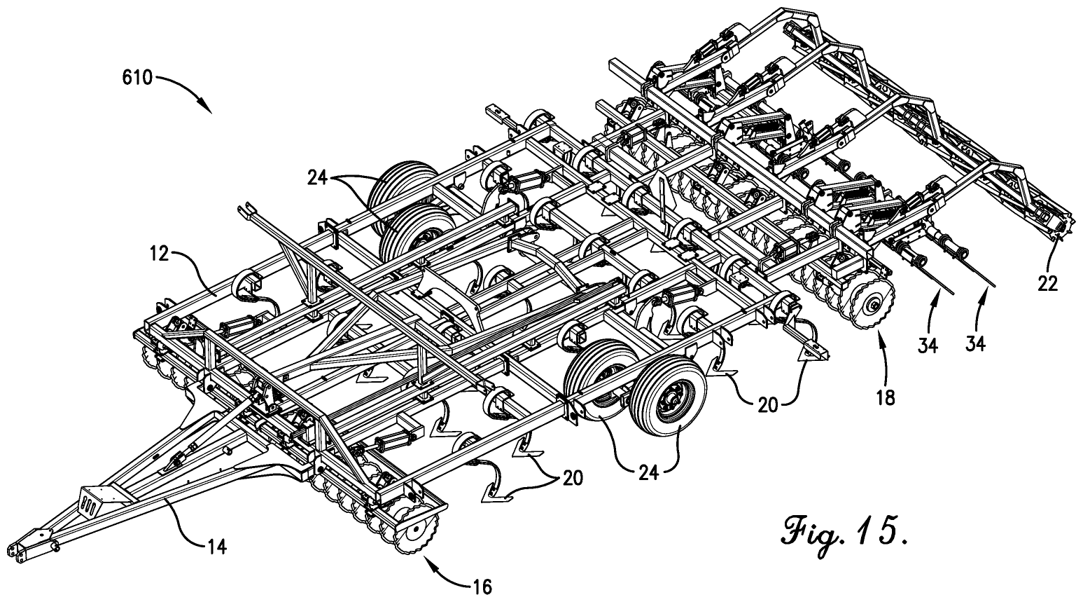

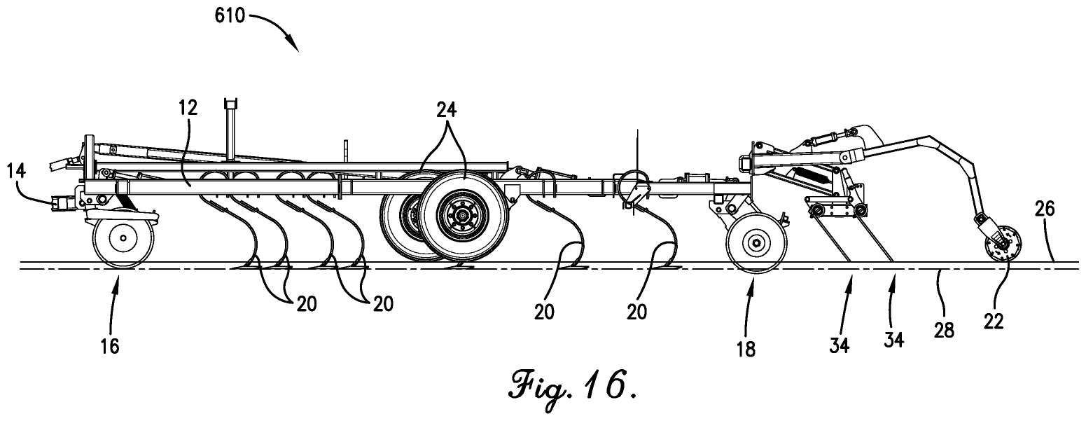

For example, FIGS. 15 and 16 show a seventh embodiment of a secondary tillage implement or cultivator 610 that includes the spring tines 34 discussed above in connection with FIGS. 13 and 14, but which includes only a single finishing reel 22. In other embodiments the finishing reel(s) 22 may be completely eliminated, moved (such that, e.g., they are provided before the spring tines 34 or otherwise), or even additional finishing reels 22 may be added without departing from the scope of the invention.

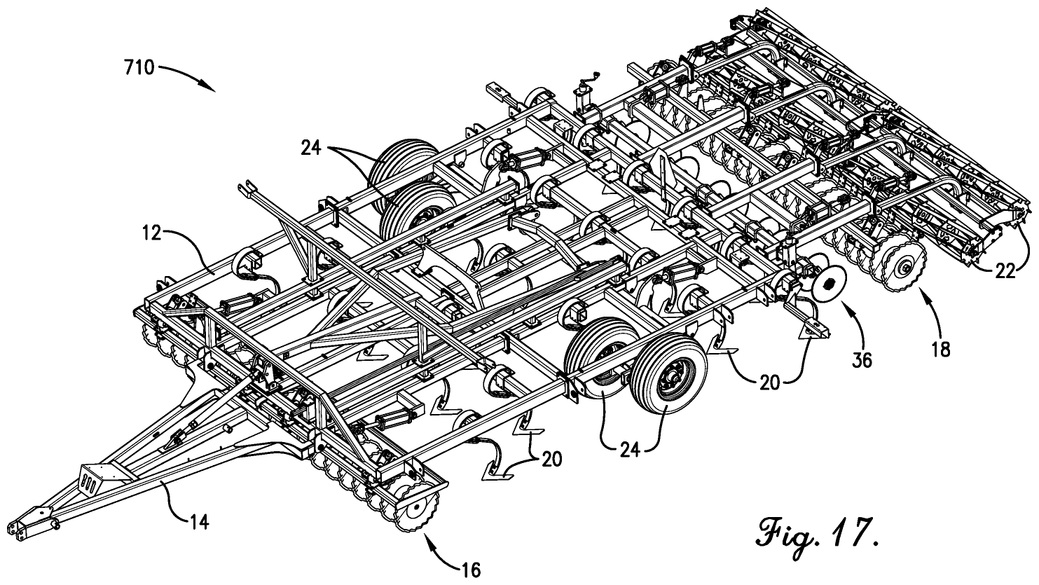

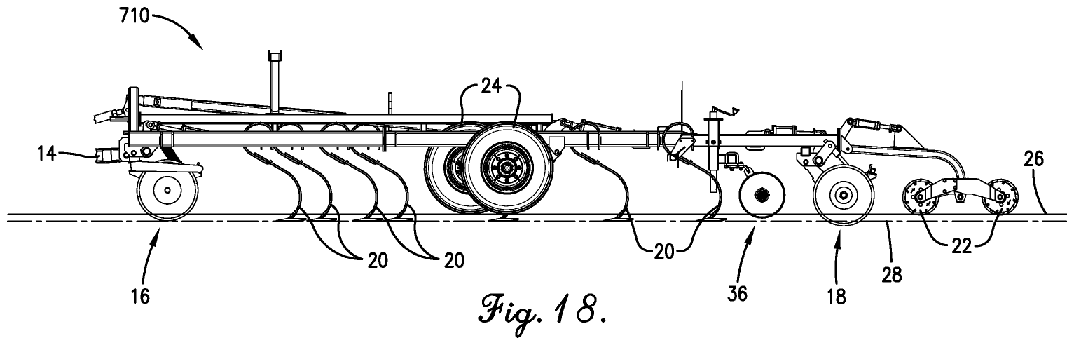

FIGS. 17 and 18 show a secondary tillage implement or cultivator 710 according to an eighth embodiment of the invention. In this embodiment, the cultivator 710 additionally includes a row of finishing discs 36. In other embodiments, the cultivator 310 could include more or less rows of finishing discs 36 without departing from the scope of the invention. The row of finishing discs 36 serve to further level the soil leaving the cultivator sweeps 20 by chopping up clods of soil and crop remnants in mounds leaving the sweeps 20 and filling in trenches formed by the sweeps 20, thus providing a level field suitable for planting.

In this embodiment, the row of finishing discs 36 is disposed in front of the trailing coulters 18. In other embodiments, the row of finishing discs 36 may be provided elsewhere (e.g., behind the trailing coulters 18) without departing from the scope of the invention. Finally, this embodiment includes two finishing reels 22 behind the row of finishing discs 36 and trailing coulters 18, similar to the embodiment shown and described in connection with FIGS. 1-4, but in other embodiments more or less finishing reels 22 could be implemented or the finishing reels 22 could be eliminated altogether without departing from the scope of the invention.

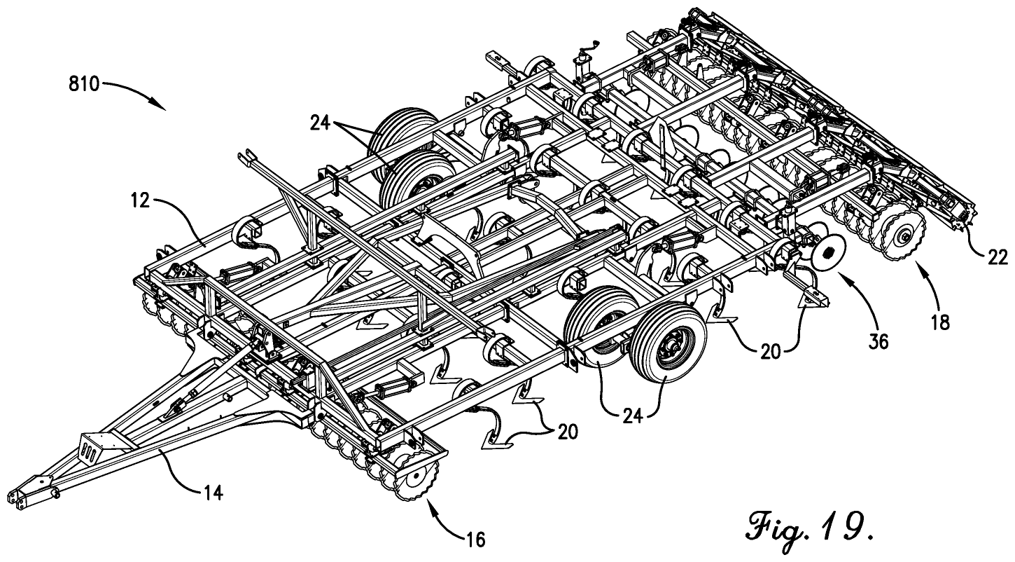

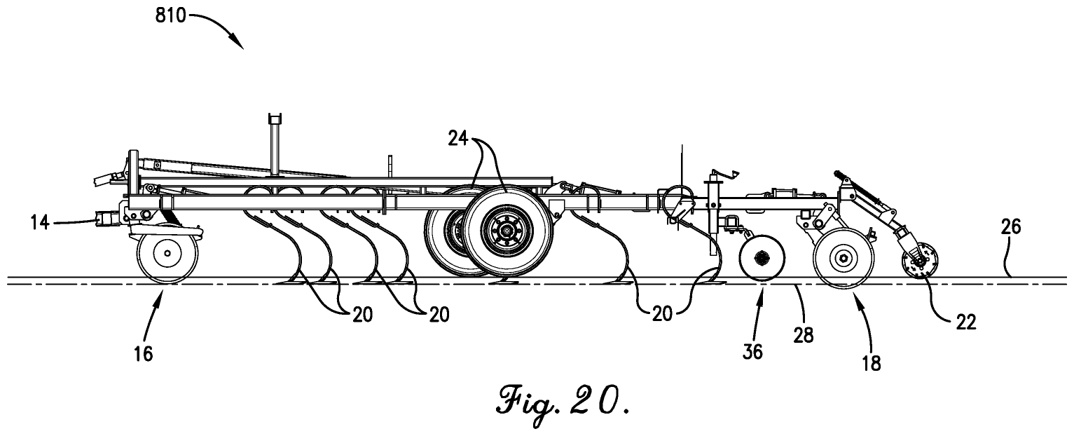

For example, FIGS. 19 and 20 show a ninth embodiment of a secondary tillage implement or cultivator 810 that includes the row of finishing discs 36 discussed above in connection with FIGS. 17 and 18, but which includes only a single finishing reel 22. In other embodiments the finishing reel(s) 22 may be completely eliminated, moved (such that, e.g., they are provided before the row of finishing discs 36 or otherwise), or even additional finishing reels 22 may be added without departing from the scope of the invention.

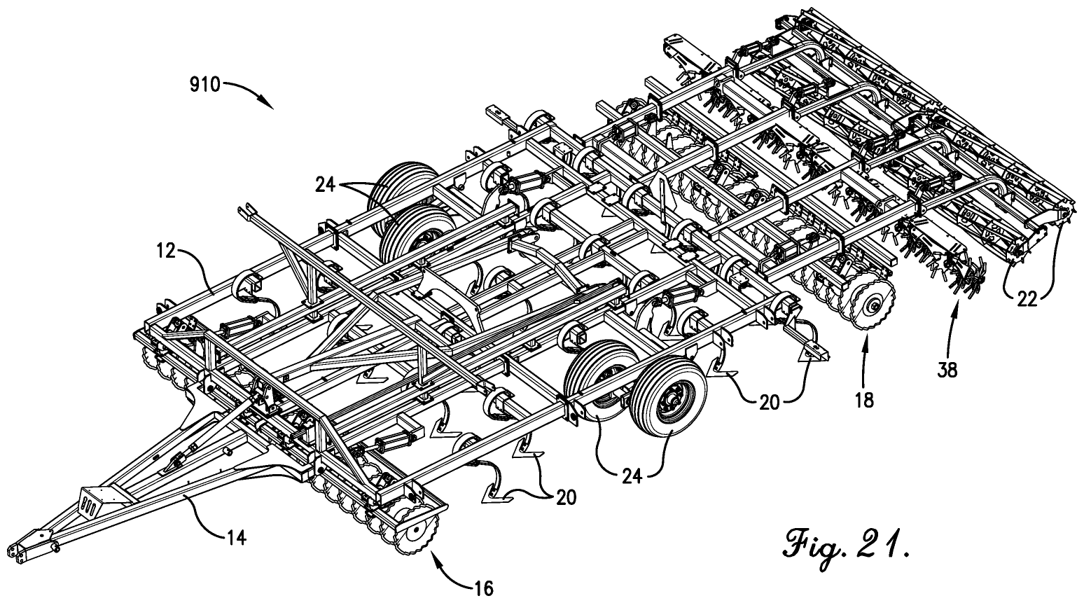

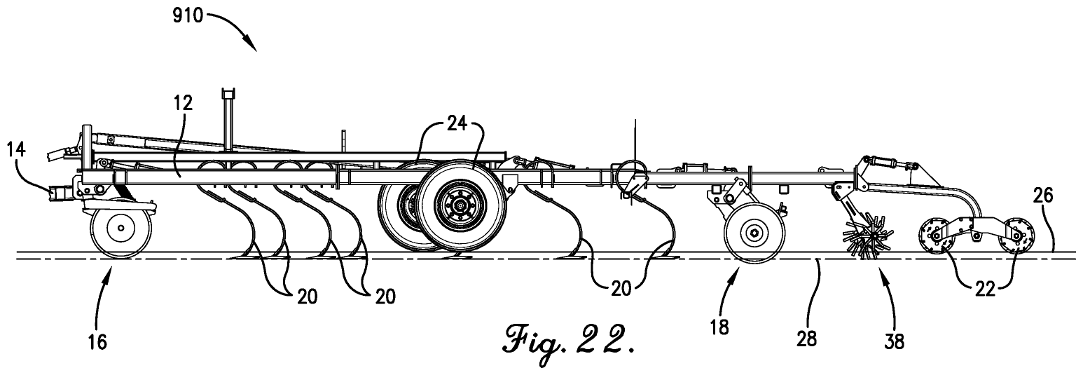

FIGS. 21 and 22 show a secondary tillage implement or cultivator 910 according to a tenth embodiment of the invention. In this embodiment, the cultivator 910 additionally includes a treader wheel 38. In other embodiments, the cultivator 310 could include more or less treader wheels 38 without departing from the scope of the invention. The treader wheel 38 serves to further level the soil leaving the cultivator sweeps 20 and trailing coulters 18 by chopping up clods of soil and crop remnants in mounds leaving the sweeps 20 and coulter 18 and filling in trenches formed by the sweeps 20 and coulter, thus providing a level field and seedbed suitable for planting.

In this embodiment, the treader wheel 38 is disposed behind the trailing coulters 18. In other embodiments, the treader wheel 38 may be provided elsewhere (e.g., in front of the trailing coulters 18) without departing from the scope of the invention. Finally, this embodiment includes two finishing reels 22 behind the treader wheel 38 and trailing coulters 18, similar to the embodiment shown and described in connection with FIGS. 1-4, but in other embodiments more or less finishing reels 22 could be implemented or the finishing reels 22 could be eliminated altogether without departing from the scope of the invention.

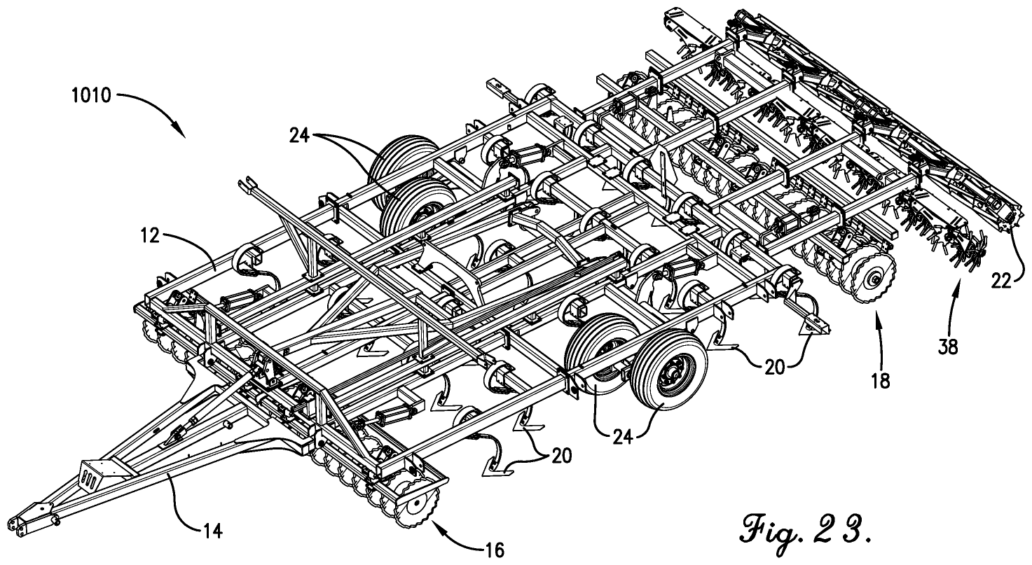

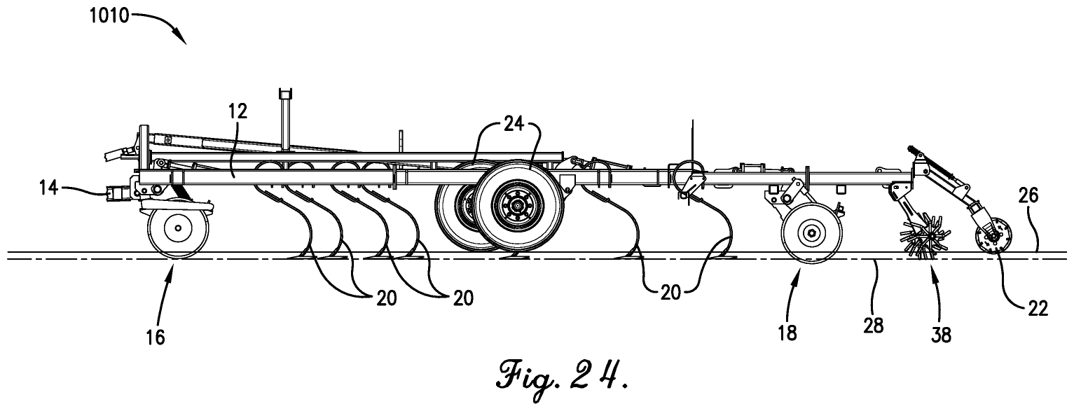

For example, FIGS. 23 and 24 show an eleventh embodiment of a secondary tillage implement or cultivator 1010 that includes the treader wheel 38 discussed above in connection with FIGS. 21 and 22, but which includes only a single finishing reel 22. In other embodiments the finishing reel(s) 22 may be completely eliminated, moved (such that, e.g., they are provided before the treader wheel 38 or otherwise), or even additional finishing reels 22 may be added without departing from the scope of the invention.

What is claimed is:

1. An implement for tilling soil, the implement comprising:
a plurality of cultivator sweeps;
a plurality of trailing coulters positioned behind a rearmost row of the plurality of cultivator sweeps; and
a finishing attachment positioned proximate the plurality of trailing coulters,
wherein the plurality of trailing coulters are configured to penetrate deeper into the soil than the plurality of cultivator sweeps.

2. The implement of claim 1, wherein each of the plurality of trailing coulters is substantially flat.

3. The implement of claim 1, wherein the plurality of trailing coulters are gang mounted on a common shaft.

4. The implement of claim 1, wherein the finishing attachment includes one of a finishing reel, a plurality of flex tines, a chopper wheel, a plurality of spring tines, a plurality of finishing discs, and a treader wheel.

5. The implement of claim 1 further comprising a plurality of front coulters positioned in front of a forwardmost row of the plurality of cultivator sweeps.

6. The implement of claim 5, wherein adjacent front coulters of the plurality of front coulters are spaced a first distance apart, and wherein adjacent trailing coulters of the plurality of trailing coulters are spaced a second distance apart, and wherein the first distance is different than the second distance.

7. The implement of claim 6, wherein the first distance is greater than the second distance.

8. An implement for tilling soil, the implement comprising:
a plurality of front coulters;
a plurality of trailing coulters;
a plurality of cultivator sweeps between the plurality of front coulters and the plurality of trailing coulters; and
a finishing attachment positioned proximate the plurality of trailing coulters.

9. The implement of claim 8, wherein each of the plurality of trailing coulters is substantially flat.

10. The implement of claim 8, wherein the plurality of trailing coulters are gang mounted on a common shaft.

11. The implement of claim 8, wherein the finishing attachment includes one of a finishing reel, a plurality of flex tines, a chopper wheel, a plurality of spring tines, a plurality of finishing discs, and a treader wheel.

12. The implement of claim 8, wherein adjacent front coulters of the plurality of front coulters are spaced a first distance apart, and wherein adjacent trailing coulters of the plurality of trailing coulters are spaced a second distance apart, and wherein the first distance is different than the second distance.

13. The implement of claim 12, wherein the first distance is greater than the second distance.

14. The implement of claim 8, wherein the plurality of trailing coulters are configured to penetrate deeper into the soil than the plurality of cultivator sweeps

15. A method of tilling soil, the method comprising:
(a) passing a plurality of cultivator sweeps through the soil;
(b) passing a plurality of trailing coulters through the soil after the plurality of cultivator sweeps; and
(c) passing a finishing attachment over and/or through said soil,
wherein each of the plurality of cultivator sweeps is coupled to a substantially vertically extending rear shank,
wherein during the passing of step (a), the plurality rear shanks and/or the plurality of cultivator sweeps cause lateral and vertical movement of said soil, and
wherein the passing of steps of (a) and (b) includes penetrating deeper into the soil with the plurality of trailing coulters than with the plurality of cultivator sweeps.

16. The method of claim 15, wherein each of the plurality of trailing coulters is substantially flat.

17. The method of claim 15, wherein the passing of steps (a), (b), and (c) is performed at a speed of 8 mph or greater.

18. The method of claim 15, wherein during the passing of step (b), the plurality of trailing coulters contact the laterally moving soil to impede further lateral movement of the soil.

19. The method of claim 15 further comprising (d) passing a plurality of front coulters through the soil before the plurality of cultivator sweeps.

20. The method of claim 15 further comprising (d) passing another finishing attachment over and/or through said soil.
